(19) United States
(12) Patent Application Publication
(10) Pub. No.: US 2011/0135279 A1
(43) Pub. Date: Jun. 9, 2011

(54) METHOD FOR CREATING AN AUDIOVISUAL MESSAGE

(76) Inventor: Jay Leonard, Birdseye, IN (US)

(21) Appl. No.: 12/961,310

(22) Filed: Dec. 6, 2010

Related U.S. Application Data
(60) Provisional application No. 61/266,999, filed on Dec. 4, 2009.

(51) Int. Cl. G11B 27/00

(52) U.S. Cl. 386/278; 386/E05.028

(57) ABSTRACT

A method for creating an audiovisual message from a subject includes the steps of providing an A/V recording space with a thematic setting; providing A/V recording equipment operable to create an audiovisual recording of a subject; providing computer apparatus including data storage means suitable to receive and hold audiovisual recordings and audiovisual messages of subjects, modem apparatus providing Internet connection, and computer software for processing audiovisual recordings to create audiovisual messages, managing multiple audiovisual messages stored on the data storage apparatus, and selectively making the audiovisual messages of subjects stored on the data storage apparatus available for remote access and at least one of viewing and downloading by remote users through the Internet connection; providing at least one interview script; interviewing the subject in accordance with the script; recording the subject with the A/V equipment during at least a portion of said interviewing step to create an audiovisual recording on the data storage means; processing the audiovisual recording to create an audiovisual message; and, storing the audiovisual message on the data storage means.

### REFERENCE TO RELATED APPLICATIONS

This application claims the benefit of the filing date of Provisional Application No. 61/266,999, filed Dec. 4, 2009, all of which is hereby incorporated by reference.

### FIELD OF THE INVENTION

The present invention relates to the field of audiovisual recording, and more specifically, to a method for creating and managing an audiovisual message.

### BACKGROUND OF THE INVENTION

Since the creation of the first permanent photograph in 1826 by Joseph Nicéphore Niépce using a sliding wooden box camera, still cameras, movie cameras and video cameras have been used to produce hundreds of millions of photographs, movies and videos worldwide. These frozen images in time chronicle births and birthdays, sporting events, movie stars, landscapes and still lifes, family members and friends, celebrations and tragedies, and any and all types of events where one has some sort of photographic recording device and a subject of interest to shoot. People photograph or record these people, things and events to provide a lasting memory more permanent and reliable than fragile human memories. These images are often passed on to family members and friends so that, when the person, thing or event (the “subject”) in the photograph is absent, gone and a distant memory, the new owner of the images will be able to remember the subject as it appeared at the time the image was taken.

In his Sermon LXXV entitled, The Reputation of Good Men After Death, Dr. John Tillotson, Late Archbishop of Canterbury (1630-1694) said, “eminently good men do commonly leave a good name behind them, and transmit a grateful memory of themselves to after-ages.” Such memories are typically borne by deeds, writings and interactions with others. With today's technology, however, and the advent of the computer and the Internet, and of image posting sites such as YouTube.com, Myspace.com and Facebook.com, people post images and videos for registered users, or in many cases, for anyone to see online. Such images and videos may be posted with or without the human subject's permission, and though they may often be entertaining, they may not necessarily be flattering. In the latter case, the subject may be eternally remembered by the posted recording of a demeaning or embarrassing momentary action that does not accurately reflect the true nature and character of that person. This Internet-driven explosion of information sharing has thus had the unfortunate effect of eroding the people's control over their own reputation.

It is desired to reclaim some measure of control of one's reputation and everlasting memory.

### SUMMARY OF THE INVENTION

Generally speaking, a method for creating, managing and making an audiovisual message from a subject selectively available over the Internet includes the steps of providing an A/V recording space with a thematic setting; providing A/V recording equipment operable to create an audiovisual recording of a subject; providing computer apparatus including data storage means suitable to receive and hold audiovisual recordings and audiovisual messages of subjects, modem apparatus providing Internet connection, and computer software for processing audiovisual recordings to create audiovisual messages, managing multiple audiovisual messages stored on the data storage apparatus, and selectively making the audiovisual messages of subjects stored on the data storage apparatus available for remote access and at least one of viewing and downloading by remote users through the Internet connection; providing at least one interview script; interviewing the subject in accordance with the script; recording the subject with the A/V equipment during at least a portion of said interviewing step to create an audiovisual recording on the data storage means; processing the audiovisual recording to create an audiovisual message; and, storing the audiovisual message on the data storage means.

Further objects and advantages of the present invention will become apparent from the following description of the preferred embodiment.

### BRIEF DESCRIPTION OF THE DRAWINGS

FIG. 1 is a block diagram showing a method 10 for creating an audiovisual message from a subject in accordance with one embodiment of the present invention.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated herein are contemplated as would normally occur to one skilled in the art to which the invention relates.

Generally speaking, the present invention relates to a system for producing an audiovisual recording of a subject As used herein, the subject can be a single person, two or more of persons (a group), one or more animals such as pets or wildlife, an event (e.g. a wedding, football game or fireworks display), a scene (e.g. a sunset, house, waterfall, or The Great Pyramids), or any other person place or thing of interest. In the following discussion, however, the term subject will mean a person or persons unless specified otherwise, and use of the term “him” or “his” shall be intended to include pronouns of either gender as well as the plural and neutral forms thereof, as applicable.

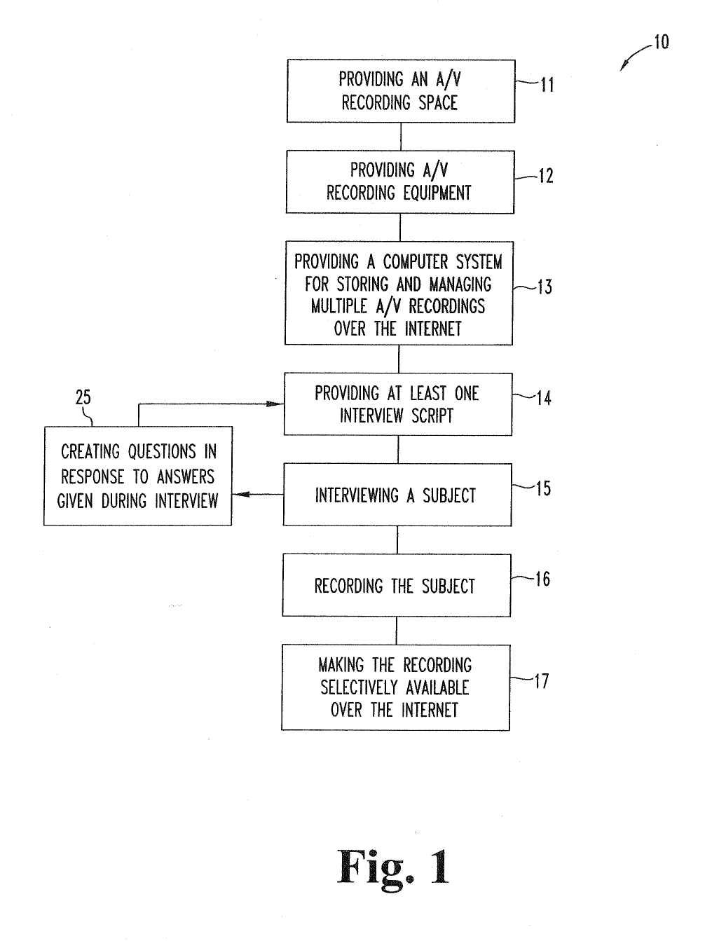

Generally speaking and referring to FIG. 1, a method 10 for creating an audiovisual message from a subject in accordance with the present invention includes providing (11) an audiovisual (A/V) recording space; providing (12) A/V recording equipment operable to create an A/V recording of a subject; providing (13) a computer system for storing and managing multiple A/V recordings for selective access over the Internet; providing (14) at least one interview script; interviewing (15) the subject in accordance with the script; recording (16) the subject during at least a portion of the interview to create an audiovisual message; and, (17) making the audiovisual message selectively available over the Internet.

Providing an A/V recording space generally includes providing a space in which the interview can take place. Such space is created to define and/or is intentionally selected because it inherently defines a thematic setting. The invention contemplates providing a variety of different thematic settings from which the subject can be interviewed, the number and variety of which are virtually endless. In one embodiment, the space is defined within a building or other structure (the “store”) specifically used for the interviewing process. Such structure has defined therein one or more interview areas configured to define the particular thematic setting. For example, one thematic setting is the home living room and includes some combination of one or more of any of the following items: carpet, a couch, a chair, a coffee table, an end table, a lamp, a bookcase, books, magazines, vases, plants, knick-knacks, and any other items that create a setting one might find in a typical living room. Examples of other thematic settings include, without limitation, a kitchen, garage, game room, bar, sporting arena, and grocery store. The thematic setting may also be outdoors. For example, the backyard of a home, a grassy field, a cave, a campground, a sandy beach, the rim of the Grand Canyon—these and any other space imaginable are contemplated to be the subject of a thematic setting of the recording space. Each can be used as it exists naturally, can be created indoors to resemble the outdoor setting, or can exist outdoors with added props, lighting, etc. to contribute to and augment the intended feeling of the thematic setting. The thematic setting may be at the subject's own home or other place of residence. Thus the creator will set up the A/V recording equipment, create the desired thematic setting and conduct the interview(s) wherever the subject is located.

Providing A/V recording equipment generally includes providing at least one video camera, and, if desired or necessary, lighting apparatus and/or separate sound recording apparatus to augment or supplement any sound recording capability of the video camera. The video camera may be any suitable device or devices operable to record both video and audio images to an audiovisual recording. As used herein, the term “video camera” means a camera for electronic motion picture acquisition and is contemplated to include any of the following commonly known and commercially available devices: a video camera system (separate video camera unit connected via a cable, wirelessly or otherwise to a separate recording device); a camcorder (video camera unit and video recorder combined into one unit), such as a Sony Handycam® video camera); and a digital camera that converts the signal directly to a digital output, stored on any appropriate media such as optical disc, hard drive and flash drive (such as in a mobile phone, PDA or laptop). As used herein, the term “video camera” is intended to mean a single camera as well as multiple cameras used during the same interview of a subject to capture the subject from more than one angle and/or in more than one thematic settings. The video camera is contemplated to acquire and record both video and audio information, the audio portion contemplated to be augmented, if desired, by additional, separate audio recording hardware.

The lighting apparatus is contemplated to comprise any device operable to emit light in a desired direction, including toward the subject and/or toward areas around the subject to produce a desired effect in accordance with the desired thematic setting. Such lighting apparatus may also include, as desired, elements operable to reflect, filter, block and/or diffuse light to help achieve the desired thematic setting. The sound recording apparatus is contemplated to be any suitable sound recording device operable to record sound to a sound recording for use in conjunction with an audiovisual recording of the video camera. The sound recording, if made, may be edited into the audiovisual recording. The sound recording apparatus also includes, if desired, synching apparatus operable to facilitate synching the sound recording to the audiovisual recording, such synching apparatus including, without limitation, a clapperboard, as is known in the art.

The A/V recording equipment may also include a still camera, that is, one capable of recording still images. Such still images (use of the plural is intended to include the singular as, for example, if only one image is used) may comprise the sole video source of the audiovisual message or they (or it) may be combined with one or more separately recorded moving images and/or audiovisual recordings.

The video camera (and sound recording apparatus, if used) may be connected directly to the computer system so that the recordings are stored directly to the computer system as they are made, or they may be recorded to memory storage media separate from the computer system (i.e. in the camera itself or in a memory device such as an external recorder or hard drive, separate from the camera), and such recordings are then uploaded to the computer system at a suitable time thereafter.

Providing a computer system generally includes providing any suitable computer with data storage memory capacity large enough to receive and store the computer operating system, all the audiovisual media (including the audiovisual messages) contemplated to be stored on the computer, and one or more software programs for managing the audiovisual recordings and Internet interaction, as described herein. The computer also includes a modem (or any similar device) operable to enable the transmission of data to and from the computer via telephone, cable or other communication lines to interactively connect the computer with the Internet. Such computer systems are well known and any configuration operable for storing and managing the audiovisual messages and making such audiovisual messages available for viewing and/or download over the Internet, as described herein, is contemplated.

The computer system includes an operating system (such as Windows 7) and a database management application (DBMA), to manage the audiovisual recordings uploaded to the computer system, as described herein. The DBMA may be off-the-shelf (such as Microsoft Access®, Oracle®, etc.), custom designed software, or some combination thereof. The computer system also includes Web server software (such as Apache) to provide both static content and dynamic Web pages and, thus, interactive Internet activity relating to the audiovisual messages stored on the computer (now the Web server). Overall audiovisual message management is provided by the database guardian. The database guardian comprises the DBMA and the Web server software operating together, with or without additional software, if desired, to provide remote users, through the Internet, selective access to view and/or download the audiovisual messages. The selective access includes free or cost-based access, with or without a password, as described herein. In one embodiment, the Web server includes an Internet access protocol that requests entry of a username (UN) and password (PW) from a remote user and, upon a valid entry of the UN/PW, the Web server admits the remote user access to a requested audiovisual message.

The computer of the computer system may be a single computer containing all the hardware and software elements (i.e. data storage memory, audiovisual recordings (messages), software programs, modem, etc.), or it may comprise multiple computers and/or servers and/or modems each containing one or more of such hardware and software elements.

The computer system also includes software operable to edit the audiovisual recordings, as described herein. Audiovisual recordings, unedited or having been edited, as described herein, that are deemed to be in the desired condition for posting are referred to as audiovisual messages. All the audiovisual messages are audiovisual recordings. All the audiovisual recordings, images, sound recordings and any other information or data stored on the computer in electronic form for potential use in an audiovisual message is referred to generally as audiovisual media.

The computer, configured for Internet connection whereby users can access the collection of audiovisual messages through Internet access and database management software is referred to herein as the host computer. The entity responsible for administering, conducting and managing the subject interview, editing the recording(s), and posting of the audiovisual message is the creator. The entity acting to oversee the host computer, messages stored thereon and the ongoing Internet interactivity with the host computer and remote users is the administrator.

The interview script comprises questions and discussion topics specifically designed to illicit answers and open discussion by the interview subject. The interview script, described more fully below, is prepared in advance of the interview and varies, depending on the interview level chosen by the subject.

Referring to the interview level, there are multiple interview levels from which the subject can chose, and each level includes a variety of interview parameters, including but not limited to: number of questions, type and content of questions, interactivity of the questions, duration of the interview, duration of the audiovisual message, number of different locations where the interview is conducted, physical location(s) of the interview, number of choices of thematic settings, elaborateness of available thematic settings, detail of editing, and level of Internet posting.

Duration of the audiovisual message means the uninterrupted amount of time it takes for the audiovisual message to play.

Detail of editing includes the amount of time spent editing, the type of editing conducted, and the amount, if any, that other audio, visual or audiovisual data is added to the original audiovisual recording(s).

In one embodiment, there are four interview levels (L1-L4) available to the subject, the fee increasing for each successive level. Each level provides more interview time, more questions (and/or discussion topic opportunities), and/or more complex questions (and/or discussion topic opportunities). Editing the raw recording to produce a more polished, final audiovisual message is contemplated in at least the higher levels. Thus, the first level, for example, contains no or substantially no editing. That is, the interview would be posted (made available for viewing and/or downloading) exactly as it is recorded. If a particular level includes editing (or is chosen, for example, as an element of a cafeteria plan), the editing could be minimal, such as simply deleting awkward silences or mistaken or misspoken responses. Alternatively, the editing could be substantial, such as editing out silences, inarticulate, objectionable or unflattering responses, and undesirable images or audiovisual segments resulting from bad camera angles; adding titles, credits and voiceovers; and inserting additional audio, visual and/or audiovisual recordings recorded at other times specifically for the present audiovisual recording or recorded by the subject(s) or others. Generally, the time, content and “polish” provided in editing will depend on the fee charged for that level.

In each level, a theme will intentionally guide and shape the interview. In the lowest level, the theme is substantially, “This is who I am, where I'm from, etc.” In successively higher levels, the interview time increases; the questions are more complex and interrelated; and, there are more themes from which to choose. Also at higher interview levels, the questioning becomes more interactive. Thus, instead of only simple questions from a preplanned list, questions may be posed in response to previous answers to create a dialog between the interviewer and subject (25 in FIG. 1).

Also at the higher levels, thematic settings become more complex. In one embodiment, for example, the thematic setting is a campsite in the woods and is chosen to enable the subject to portray himself as an independent outdoorsman. The interview script would include questions directed to the subject's camping experiences and abilities and the friends with whom he has shared those experiences. Lower levels would have only a few basic questions in accordance with the theme, while upper levels would be custom tailored to the subject's life to explore, extract and expound upon his experiences. Editing in the latter case would then create the desired audiovisual message, a polished audiovisual presentation about the subject.

The levels of one embodiment are comprised as follows:

L1—this is the basic level (referred to as: MY 15 minutes of VIMM), wherein the subject is interviewed, in the store, in a basic interview room, from a standard script and for a basic, threshold amount of time, such as 15 minutes. VIMM refers to “virtual immortality”. The subject might choose to read the questions and answer them himself, or he may chose to have another person read the questions to him—that is, to interview him.

L2—this is the extended level (MYVIMM EXTENDED) and is the same as the basic level L1, but it lasts longer, such as 25 minutes, and the script is longer—that is, more questions may be selected by the subject and posed to him during the interview. Some basic editing may also be provided to clean up gaps and silences, stammering and other awkward and unflattering responses, comments, and so on.

L3—this is the total VIMM level (MY TOTAL VIMM). Here, the subject is provided a choice of several thematic settings, indoor or outdoor, and the script is longer and more comprehensive. An interviewer will still follow the script questions and discussion topics, but he may deviate where appropriate to extend the interview and get the interviewee to open up and storytell, or provide long opinions. The interview duration may last much longer than lower levels (e.g. two hours), and post interview editing will pare the recording down to a 45 minute audiovisual message.

L4—this is the ultimate VIMM (MY ULTIMATE VIMM) and is the same as level L3, but it is longer and more in depth. The interviewer may get the subject to deviate substantially from the script and to discuss more of his life, successes and accomplishments. The number and complexity of the thematic setting selections are greater and the post interview editing will allow insertion of additional images and videos recorded specifically for the subject's present project or provided by the subject from his own collection of images and recordings.

Alternative embodiments are contemplated wherein there are fewer or greater levels and wherein the interview parameters (number of questions, type and content of questions, interactivity of the questions, duration of the interview, length of the final audiovisual message, location of the interview, number of choices of thematic settings, elaborateness of available thematic settings, detail of editing, and level of Internet posting) of each level varies from that described for levels L1-L4. For example, the levels L1-L4 may be as described above, except that the subject may choose any thematic setting, the cost for which being a separate, additional cost. In another example, the subject may select as many questions as she wishes, which she ranks, and each level will have a set duration. Thus, the number of questions asked will depend on how fast the questions are asked and answered.

Alternative embodiments are contemplated wherein a build-it-yourself level LX is available. In the LX level, the subject can select the desired interview parameters from a menu where each item is individually priced and the subject can tailor the interview, thematic setting, editing and other parameters to his needs and liking. Thus, the subject may select the most basic setting (in-store in the standard room with a chair), the most basic Internet posting option (the Internet user pays a one time fee each time the audiovisual message is viewed), and no editing, but the interview is simply the subject providing his own 30 minute monologue.

The interview script of each interview level provides a list of the questions that will be asked, is prepared in advance of the interview and varies, depending on the interview level chosen by the subject. Exemplar of such interview questions and discussion topics are as follows:

What was the best day of your life?

What was the worst day of your life?

What was your first car?

What was your first job?

What was your worst subject in school?

What is your favorite candy bar?

What game show would you want to be on?

What was the best present you received as a child?

What is your favorite TV show?

What is your favorite movie?

If you won lottery tomorrow, what be the first thing you would do?

Have you ever seen a ghost?

What is your perfect Sunday morning?

What is your best physical feature?

If you could live anywhere, where would it be?

What was the scariest nightmare you have had?

Have you ever seen a UFO?

What is your favorite sport to watch?

What is your favorite sport to play?

What is your favorite dessert?

How many siblings do you have?

What was your school mascot?

What was the funniest thing you ever saw?

Of all your possessions, which one do you treasure the most?

What was your best vacation?

If you had to live off one food for a month, what would it be?

What would be your dream job?

What was your best subject in school?

When was the last time you cleaned out your car?

How many speeding tickets have you ever gotten?

Who the most famous person you have ever met?

Who do you miss the most?

Who upsets you the most?

What would you call the best invention ever?

What is your favorite soap opera?

How many birthday parties have you had?

In what color do you look best?

What is your favorite color for a car?

Whom would you most like to meet?

What is your favorite video game?

What would be your perfect Saturday night?

What do you enjoy most about your job?

What is the one thing you want, but do not yet have?

Who is the neatest person you know?

If you could be anywhere tomorrow morning, where would it be?

What is your biggest fear?

What is your favorite amusement park ride?

What is the best concert you ever saw?

Where were you when you heard Elvis died?

What is the most amount of money you have spent in a day?

What is your perfect day?

What is your perfect night?

What is your favorite song to dance to?

What is your favorite game show?

What is the prettiest beach you have ever seen?

Do you believe Bigfoot exists?

What is favorite flavor of ice cream?

What is your favorite form of exercise?

What is your dream car?

Where is your favorite place to shop?

What is your favorite website?

Who is your favorite entertainer?

What was your best day?

Which room in your home is the messiest?

What scares you the most?

In the four level embodiment (L1-L4), for example, level L1 includes the subject selecting up to 15 of the above questions; in L2, the subject may select up to 25 of the above questions; in L3, the subject may select up to 35 of the above questions, plus she may provide up to 10 of her own; and, L4 includes all the questions options of L3, plus the interviewer is free to ask any questions that she may think of. Interactivity (the interviewer asking one or more follow up questions in view of the subject's response) may be available in all the levels, but it is preferred that it be a feature of only the higher levels.

The interviewing a subject step includes obtaining from the subject certain reference information, which will be entered into the computer database, in connection with the subject's audiovisual message. The reference information will be accessed by the MYVIMM search engine (described below) to allow a remote user to locate audiovisual messages of interest through entry of keywords. The reference information is contemplated to be any information that will permit quick and reliable location of desired audiovisual messages, such as, first, last and maiden names, cities of birth and residence, name(s) of school(s) attended, place(s) of employment, teams and clubs of membership, and so on. Thus, one might search for Katy Price, former member of the Adams High School State Volleyball Champions in 2006 by entering some combination of the terms: “Katy” “Price” “Adams” “Volleyball” “Champion”. If Katy has made an audiovisual message that resides on the MYVIMM database, it would be located by the search engine and displayed for the user to select for viewing.

There are contemplated to be multiple access protocols for locating and viewing audiovisual messages through the MYVIMM Website. One access protocol includes a MYVIMM search engine, which includes a search box on one or more of the MYVIMM Website pages in which the user can enter one or more keywords and search for audiovisual messages of interest. The search terms will relate to the reference information entered by the subject and corresponding to his audiovisual message stored on the host MYVIMM computer. For example, the user could search for “Johnson” and “Notre Dame” and find an audiovisual message about Mike Johnson, a Notre Dame graduate. The user would then select the option to view the audiovisual message upon satisfying any pre-access parameter that the MYVIMM site requires, such as payment and/or a password. If payment is required, the MYVIMM site is configured by any suitable method for making payment over the Internet, such methods being readily known. Another form of payment (as a pre-access parameter) is pre-payment whereby the subject prepays for one, multiple or unlimited access by users through the MYVIMM website If a password is required, it is because the access protocol selected by the subject included PW access whereby location and/or viewing of the audiovisual message requires entry of a PW. The subject will create the PW during the initial set-up process, and the PW will be distributed by the subject as he desires.

Another access protocol provided by the Web server is the ability to access a desired audiovisual message by an identification code, such as a reference number. Each audiovisual message is automatically provided with a reference number (RN). The subject is given the reference number upon completion of the interview and audiovisual message finalization process, and she may use it herself and/or give it to other for quick access to the audiovisual message. The remote user simply types the RN into the search box (or into a separate, dedicated reference number search box), and either the corresponding audiovisual message will be accessed (if access to the audiovisual message is free or has already been made available through pre-payment) or a link to the corresponding audiovisual message will pop up, whereby the user can complete the access procedure by providing payment or a preset access code. The invention contemplates a variety of access and payment options in addition to the above. For example, as part of the variety of interview parameters, different levels may provide for a pre-paid number of visits to a particular audiovisual message, after which a remote user must pay for each subsequent access.

Once the recording(s) is made and stored on the computer, and any desired editing is performed, the resulting audiovisual message is ready for publication. In one embodiment, the audiovisual message is stored on the computer and is available for access by users through the Internet. A dedicated website (the “MYVIMM Website”) provides access to the various audiovisual messages and can be accessed by anyone in accordance with the access protocol applied to that audiovisual message.

Alternative embodiments are contemplated wherein the audiovisual message is transferred to a transportable physical storage media, such as a DVD, CD, flash drive or similar physical and readily transportable device. Instead of or in addition to the Internet posting, the creator of the audiovisual message can provide the subject with his audiovisual message directly on the transportable physical storage media.

Alternative embodiments are contemplated wherein the recording space is remote in the form of a kiosk, a booth, or a room, dedicated for use to record a subject and being physically separate from the host computer and store. These remote, dedicated spaces are collectively referred to as remote recording spaces, and are contemplated to be located at areas of consumer traffic, such as and without limitation, a mall, an amusement park or a sporting event. The remote recording space is dedicated in that any thematic setting and the A/V recording equipment is relatively fixed in place (that is, not intended for frequent moving, as opposed to a single remote thematic setting such as a campsite, for example, where the A/V recording equipment would be set up for one interview and removed upon completion of that interview.) The remote recording space may also include computer equipment that is similar to the host computer in its capacity and ability to receive and store audiovisual recordings of the interviews and, if desired, to connect with the Internet to upload such audiovisual recordings over the Internet to the host computer. The computer also includes a computer monitor and/or other information transmission device (such as an audio speaker) to communicate to the subject how to perform the interview—that is, how the interview process works, the different levels that may are available, the price for each level, the parameters of each level. The computer manages all facets of the interview process, including asking (audibly and/or visually) the questions.

In one embodiment, a portable kiosk is contemplated to be delivered and operated for a day, week or month, then moved to next location. A semi-permanent kiosk is contemplated to be positioned at or near an area of consumer traffic and to remain there as long is desired. The kiosk has the advantage of providing the desired interview recording function with very low overhead as compared to the cost of erecting a building or renting space in an existing building at the desired location. The kiosk would comprise an enclosure (to define the recording space with thematic setting) in which one or more subjects can sit or stand. The enclosure defines an opening providing ingress and egress and provides a door, curtain or similar structure to close off the opening and provide the subject(s) some measure of privacy and protection against unwanted background noise. If payment is required, the kiosk includes apparatus configured with automated payment apparatus to receive payment in the form of exchangeable currency (i.e. paper money), coupon (i.e. gift card, advertising coupon, etc.) or non-currency payment instrument (i.e. credit card, debit card, charge card, or cash card). Such payment receiving and/or entry apparatuses are well known. It is desirable that the resulting interview recording may be uploaded by and from the kiosk computer though an Internet connection directly for storage on the host computer, but the kiosk computer is also configured to store the audiovisual recordings and to enable periodic retrieval of the audiovisual recordings by the administrator.

Other dedicated remote recording spaces, such as booths and rooms, are configured to operate similarly to the kiosk, except some functions of the computer in the kiosk location may be performed by a remote interviewer, such as explaining the interview process, taking payment, and conducting the interview. Any of the thematic settings, including the remote recording space, can include use of chroma key technology whereby the interview recording is shot with the subject(s) positioned in front of a green screen (or similar backdrop). In editing, the color (or small color range) of the green screen is removed (or made transparent), revealing another image behind it, that other image being any scene or video consistent with the theme and thematic setting of the interview. Thus, the interview, though occurring in the bricks-and-mortar store or in the remote recording space, can be made to appear as if it took place on a beach in Hawaii or on the top of Mount Everest.

In one alternative embodiment, audiovisual messages may be posted directly from their recording, without any editing, such as at a temporarily located kiosk (at a mall or football game). It is intended, however, that the administrator retain control of the audiovisual messages such that objectionable audiovisual messages are not posted to the Website. Examples of objectionable audiovisual messages would include those deemed to constitute criminal behavior or threats to national security and those considered to be racially biased. That is, the administrator and any content monitoring software employed by the computer system would apply content monitoring standards similar to those employed by television networks, cable channels and Internet sites. In the remote kiosk and similar embodiments, therefore, additional protocols are contemplated, such as software that detects the recording of objectionable words, whereupon the posting may be delayed until the administrator can review the recording and edit it or reject it.

Another option that may be selected is to for the subject to delay the positing as, for example, a parent wishing to create an audiovisual message for his child to access when the child reaches a certain age, or when a certain event occurs, such as graduation or death of the parent.

In another embodiment, the database guardian prevents the user from downloading or copying the audiovisual message unless the interview protocol provides for it, that is, unless such downloading is authorized through prepayment by the subject or is paid for by the remote user.

Subject as used herein relates to a single individual, but alternative embodiments are contemplated wherein the subject comprises two or more individuals recorded at the same time and in the presence of each other, or separate from each other, and/or serially, one after another. In the latter case, the two or more separate audiovisual recordings would be edited into a single audiovisual message.

The order of steps 11-17 is not required to be conducted in the order shown in FIG. 1, except that the majority of the interviewing a subject step 15 will be conducted at the same time as the recording the subject step 16, and the interviewing and recording steps 15 and 16 must precede the making the recording step selectively available over the Internet step 17. That portion of the interviewing (15) a subject step wherein reference information is obtained may be conducted in the interview itself or separately before or after the interview.

Alternative embodiments are contemplated wherein the method 10 for creating an audiovisual message from a subject includes one or more of the following steps being conducted by a single entity (e.g. a person, persons, a group, a company) or by one or more other entities under the control, ownership and/or guidance of such single entity: providing (11) an audiovisual (A/V) recording space; providing (12) A/V recording equipment operable to create an A/V recording of a subject; providing (14) at least one interview script; interviewing (15) the subject in accordance with the script; recording (16) the subject during at least a portion of the interview to create an audiovisual message. Thus, for example, the subject may instruct the creator that he (the subject) has a building in which the interview is to take place, or that he has secured a third party to provide a particularly decorated park that is to serve as the thematic setting. Alternative embodiments are contemplated wherein the method 10 for creating an audiovisual message from a subject includes one or more of the following steps being conducted by the subject himself: providing (11) an audiovisual (A/V) recording space; providing (12) A/V recording equipment operable to create an A/V recording of a subject; providing (14) at least one interview script; interviewing (15) the subject in accordance with the script; recording (16) the subject during at least a portion of the interview to create an audiovisual message.

In one such embodiment, the providing (11) an audiovisual recording space step is carried out by the subject, wherein the subject (consumer) would be located at his home or other location, with a computer equipped with a webcam. The interview is conducted remotely by the creator, through the webcam and then processed (e.g. edited, stored and made available for selective access over the Internet) as described herein. In this embodiment, the providing (12) A/V recording equipment operable to create an A/V recording of a subject is, in part, also provided by the subject in the form of his computer and webcam, while the creator's computer system and webcam comprise the rest of the recording equipment.

In another embodiment, the providing (11) an audiovisual recording space step is carried out by the subject, wherein the subject (consumer) would be located at his own home or other location, with a computer equipped with a webcam. The interview is conducted through software downloaded by the subject or accessed through the Internet connection, such software providing the questions, not live by a person(s) at the other end of the connection, but by questions appearing in text form on the subject's computer or verbally by an avatar or animated interviewer appearing on the subject's computer. Such questioning is still presented and controlled by the creator, but without the need for much or any live interaction with a person at the creator's end of the Internet connection. The resulting recording received at the creator's end of the Internet connection is then processed (e.g. edited, stored and made available for selective access over the Internet) as described herein. In this embodiment, the providing (12) A/V recording equipment operable to create an A/V recording of a subject is, in part, also provided by the subject in the form of his computer and webcam, while the creator's computer system comprise the rest of the recording equipment.

In another embodiment, the providing (11) an audiovisual recording space step is carried out by the subject, wherein the subject (consumer) would be located at his own home or other location, with a computer equipped with a webcam or with some other form of recording device. The subject obtains an interview package from the creator (i.e. through the mail, a store or over the Internet), which contains the interview script, and the subject, either alone or with the assistance of another party, conducts the interview or records it on his own equipment. The resulting recording is then sent to the creator (i.e. via the mail, a store or over the Internet), whereupon such recording is then processed (e.g. edited, stored and made available for selective access over the Internet), as described herein. In this embodiment, the providing (12) A/V recording equipment operable to create an A/V recording of a subject, the interviewing (15) the subject in accordance with the script, and the recording (16) the subject during at least a portion of the interview to create an audiovisual message are also provided by the subject himself in the form of his computer and webcam or similar equipment and his own action in conducting/directing the interview.

In another embodiment, the forgoing alternatives wherein the interview is conducted at the subject's location over the subject's computer, with webcams or other recording equipment, with interview script provided by the creator, and/or conducted by the subject or his own assistant, could any or all be performed not through the subject's computer (i.e. laptop or desktop), but through or via an application transmitted through or with a mobile phone, PDA, computer tablet or similar electronic device.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

I claim:

1. A method for creating an audiovisual message from a subject, comprising the steps of:
providing an A/V recording space with a thematic setting;
providing A/V recording equipment operable to create an audiovisual recording of a subject;
providing computer means including data storage means suitable to receive and hold audiovisual recordings and audiovisual messages of subjects, modem means providing Internet connection, and computer software means for processing audiovisual recordings to create audiovisual messages, managing multiple audiovisual messages stored on the data storage means, and selectively making the audiovisual messages of subjects stored on the data storage means available for remote access and at least one of viewing and downloading by remote users through the Internet connection;
providing at least one interview script;
interviewing the subject in accordance with the script;
recording the subject with the A/V equipment during at least a portion of said interviewing step to create an audiovisual recording on the data storage means;
processing the audiovisual recording to create an audiovisual message; and,
storing the audiovisual message on the data storage means.

2. The method for creating an audiovisual message from a subject of claim 1 further including defining a plurality of interview levels for selection by a subject, each interview level defining a variety of interview parameters, including at least one of: number of questions in the interview script, type and content of the questions, interactivity of the questions, duration of the interview, duration of the audiovisual message, number of different locations where the interview is conducted, physical location(s) of the interview, number of choices of thematic settings, elaborateness of available thematic settings, detail of editing, and level of Internet posting.

3. The method for creating an audiovisual message from a subject of claim 2 wherein the processing step includes editing the audiovisual recording to achieve at least one of deleting awkward silences, deleting mistaken responses, deleting misspoken responses, deleting silences, deleting inarticulate responses, deleting objectionable responses; deleting unflattering responses, deleting undesirable images, deleting undesirable audiovisual segments, adding titles, adding credits, adding a voiceover, adding an additional audio record, adding an additional visual recording, and adding an additional audiovisual recording.
